(19) United States
(12) Patent Application Publication
(10) Pub. No.: US 2019/0317349 A1
(43) Pub. Date: Oct. 17, 2019

(54) LIQUID CRYSTAL COMPOSITION, LIQUID CRYSTAL PANEL, LIQUID CRYSTAL DISPLAY, AND ELECTRONIC DEVICE

(71) Applicant: SHARP KABUSHIKI KAISHA, Sakai City, Osaka (JP)

(72) Inventors: MASAKAZU KAMURA, Sakai City (JP); JUN SAKUMA, Sakai City (JP); SHIGERU AOMORI, Sakai City (JP); KATSUMI KONDOH, Sakai City (JP)

(21) Appl. No.: 16/313,424

(22) PCT Filed: Jun. 29, 2017
(86) PCT No.: PCT/JP2017/023923

§ 371 Date: Dec. 26, 2018

(30) Foreign Application Priority Data
Jun. 29, 2016 (JP) 2016-129180

(51) Int. Cl. G02F 1/133; G02F 1/1339; G09G 3/36; G02F 1/1345

(52) U.S. Cl. CPC G02F 1/13306; G02F 1/13392; G02F 2001/133354; G02F 1/13454; G09G 3/3688

(57) ABSTRACT

A liquid crystal composition contains liquid crystal molecules. The liquid crystal molecules include 17 mol % or more of first liquid crystal molecules represented by the following formula with respect to the whole liquid crystal molecules:

R¹—R²ₓ—R³—R⁴_{y}—R⁵ (A)

(where R¹ and R⁵ are linear alkyl groups containing 1 to 8 carbon atoms; R² and R⁴ are trans-1,4-cyclohexylene groups or 1,4-phenylene groups; R³ is a trans-1,4-cyclohexylene group, a 1,4-phenylene group, a 2,3-difluoro-trans-1,4-cyclohexylene group, a 2,3-difluoro-1,4-phenylene group, a 2,3-dichloro-trans-1,4-cyclohexylene group, or a 2,3-dichloro-1,4-phenylene group; x is an integer of 0 to 3; and y is an integer of 0 to 3).

### TECHNICAL FIELD

Some aspects of the present invention relate to a liquid crystal composition, a liquid crystal panel, a liquid crystal display, and an electronic device.

This application claims priority to Japanese Patent Application No. 2016-129180 filed in the Japan Patent Office on Jun. 29, 2016, the entire contents of which are incorporated herein by reference.

### BACKGROUND ART

Hitherto, liquid crystal displays have been widely used as displays for portable electronic device such as smartphones, televisions, personal computers, and the like. A liquid crystal panel for use in a liquid crystal display has a basic configuration including a pair of substrates, a liquid crystal layer interposed between the pair of substrates, and a sealing section placed around the liquid crystal layer, which is interposed between the pair of substrates. As a liquid crystal composition for use in the liquid crystal layer, one described in, for example, Patent Literature 1 is known.

### CITATION LIST

### Patent Literature

PTL 1: Japanese Unexamined Patent Application Publication No. 8-104869

### SUMMARY OF INVENTION

### Technical Problem

In recent years, liquid crystal panels capable of ensuring both good display quality and low power consumption have been required. In order to respond to such market requirements, various considerations such as driving circuits, driving systems, and backlights are conceivable. Liquid crystal compositions for use in liquid crystal layers have room for improvement.

Some aspects of the present invention have been made in view of such circumstances. It is an object of the present invention to provide a liquid crystal composition capable of providing a liquid crystal panel ensuring both good display quality and low power consumption. It is also an object of the present invention to provide a liquid crystal panel, liquid crystal display, and electronic device capable of ensuring both good display quality and low power consumption.

### Solution to Problem

For the above problem, the inventors have regarded the drop in voltage by the leakage of the charge applied to a liquid crystal layer during image display as a cause hindering the achievement of low power consumption and good image display. Therefore, the inventors have investigated liquid crystal compositions for use in liquid crystal layers for the purpose of achieving a liquid crystal layer from which charge is unlikely to leak, thereby completing some aspects of the present invention.

That is, an embodiment of the present invention provides a liquid crystal composition containing liquid crystal molecules. The liquid crystal molecules include 17 mol % or more of first liquid crystal molecules represented by the following formula with respect to the whole liquid crystal molecules:

R¹—R²ₓ—R³—R⁴_{y}—R⁵ (A)

(where R¹ and R⁵ are linear alkyl groups containing 1 to 8 carbon atoms;

R² and R⁴ are trans-1,4-cyclohexylene groups or 1,4-phenylene groups; multiple R² and R⁴ may be the same as or different from each other;

R³ is a trans-1,4-cyclohexylene group, a 1,4-phenylene group, a 2,3-difluoro-trans-1,4-cyclohexylene group, a 2,3-difluoro-1,4-phenylene group, a 2,3-dichloro-trans-1,4-cyclohexylene group, or a 2,3-dichloro-1,4-phenylene group; x is an integer of 0 to 3; and y is an integer of 0 to 3).

In an embodiment of the present invention, 50 mol % or more of the first liquid crystal molecules may be contained with respect to the whole liquid crystal molecules.

In an embodiment of the present invention, less than 50 mol % of second liquid crystal molecules containing an alkoxy group in the molecules may be contained with respect to the whole liquid crystal molecules.

In an embodiment of the present invention, the first liquid crystal molecules and third liquid crystal molecules, represented by Formula (A), different from the first liquid crystal molecules may be contained; the total number of R² groups and R⁴ groups in each first liquid crystal molecule may be equal to the total number of R² groups and R⁴ groups in each third liquid crystal molecule; and the difference between the sum of the number of carbon atoms in an R¹ group and the number of carbon atoms in an R⁵ group in the first liquid crystal molecule and the sum of the number of carbon atoms in an R¹ group and the number of carbon atoms in an R⁵ group in the third liquid crystal molecule may be 1.

In an embodiment of the present invention, the number of the R² groups in the first liquid crystal molecule may be equal to the number of the R² groups in the third liquid crystal molecule, the number of R⁴ groups in the first liquid crystal molecule may be equal to the number of the R⁴ groups in the third liquid crystal molecule, the difference between the sum of the number of carbon atoms in the R¹ group and the number of carbon atoms in the R⁵ group in the first liquid crystal molecule and the sum of the number of carbon atoms in the R¹ group and the number of carbon atoms in the R⁵ group in the third liquid crystal molecule may be 1, the R² groups in the first liquid crystal molecule may be the same as the R² groups in the third liquid crystal molecule, an R³ group in the first liquid crystal molecule may be the same as an R³ group in the third liquid crystal molecule, and the R⁴ groups in the first liquid crystal molecule may be the same as the R⁴ groups in the third liquid crystal molecule.

In an embodiment of the present invention, the total number of the R², R³, and R⁴ groups in the first liquid crystal molecule and the total number of the R², R³, and R⁴ groups in the third liquid crystal molecule may be both 3 and one of the R¹ and R⁵ groups in the first liquid crystal molecule and the R¹ and R⁵ groups in the third liquid crystal molecule may be an n-propyl group.

An embodiment of the present invention provides a liquid crystal panel including a pair of substrates, a liquid crystal layer interposed between the pair of substrates, and a sealing section placed around the liquid crystal layer interposed between the pair of substrates. The pair of substrates each have a surface which is located on the liquid crystal layer side and which is provided with an alignment film. The liquid crystal layer is formed from the liquid crystal composition.

In an embodiment of the present invention, the sealing section may be formed from a curable resin.

An embodiment of the present invention provides the liquid crystal panel, in which the alignment film is formed from a polymeric material containing a photofunctional group and the photofunctional group absorbs light to decompose.

In an embodiment of the present invention, one of the pair of substrates may include an electrode and a driving TFT controlling the voltage applied to the electrode and the driving TFT may include a semiconductor layer formed from an oxide semiconductor.

An embodiment of the present invention provides a liquid crystal display including the liquid crystal panel and a controller supplying a driving signal to the liquid crystal panel.

In an embodiment of the present invention, the controller may supply the driving signal of less than 60 Hz to the liquid crystal panel.

In an embodiment of the present invention, the controller may supply the driving signal of less than 30 Hz to the liquid crystal panel.

An embodiment of the present invention provides an electronic device including the liquid crystal panel and a controller supplying a driving signal to the liquid crystal panel.

In an embodiment of the present invention, the controller may supply the driving signal of less than 60 Hz to the liquid crystal panel.

In an embodiment of the present invention, the controller may supply the driving signal of less than 30 Hz to the liquid crystal panel.

### Advantageous Effects of Invention

According to some aspects of the present invention, a liquid crystal composition capable of providing a liquid crystal panel ensuring both good display quality and low power consumption can be provided. Furthermore, a liquid crystal panel, liquid crystal display, and electronic device capable of ensuring both good display quality and low power consumption can be provided.

### BRIEF DESCRIPTION OF DRAWINGS

FIG. 1A is a first illustration showing the relationship between the operating time and luminance of a liquid crystal display.

FIG. 1B is a second illustration showing the relationship between the operating time and luminance of a liquid crystal display.

FIG. 2A is a first process drawing showing a typical step of manufacturing a liquid crystal panel.

FIG. 2B is a second process drawing showing a typical step of manufacturing the liquid crystal panel.

FIG. 3 is an illustration showing an example of a liquid crystal molecule that is a major component of a conventional liquid crystal composition.

FIG. 4 is a schematic sectional view of a liquid crystal panel 11 according to a second embodiment.

FIG. 5 is a schematic sectional view of the liquid crystal panel 11 and a liquid crystal display 1 according to the second embodiment.

FIG. 6 is a circuit diagram of the liquid crystal display according to the second embodiment.

FIG. 7 is a schematic view of an electronic device according to a third embodiment.

FIG. 8 is a schematic view of the electronic device according to the third embodiment.

FIG. 9 is a schematic view of the electronic device according to the third embodiment.

FIG. 10 is a schematic view of the electronic device according to the third embodiment.

FIG. 11 is a graph showing results of examples and a comparative example.

FIG. 12 is a graph showing results of examples and a comparative example.

### DESCRIPTION OF EMBODIMENTS

### First Embodiment

### (Liquid Crystal Composition)

A liquid crystal composition according to an aspect of the present invention is a liquid crystal composition containing liquid crystal molecules. The liquid crystal molecules include 17 mol % or more of first liquid crystal molecules represented by the following formula with respect to the whole liquid crystal molecules:

R¹—R²ₓ—R³—R⁴_{y}—R⁵ (A)

(where R¹ and R⁵ are linear alkyl groups containing 1 to 8 carbon atoms;

R² and R⁴ are trans-1,4-cyclohexylene groups or 1,4-phenylene groups; multiple R² and R⁴ may be the same as or different from each other;

R³ is a trans-1,4-cyclohexylene group, a 1,4-phenylene group, a 2,3-difluoro-trans-1,4-cyclohexylene group, a 2,3-difluoro-1,4-phenylene group, a 2,3-dichloro-trans-1,4-cyclohexylene group, or a 2,3-dichloro-1,4-phenylene group; x is an integer of 0 to 3; and y is an integer of 0 to 3).

Herein, the term “liquid crystal molecule” refers to a compound exhibiting liquid crystallinity. The term “compound exhibiting liquid crystallinity” includes compounds exhibiting liquid crystallinity alone and compounds which do not exhibit liquid crystallinity alone but which exhibit liquid crystallinity under specific blended conditions.

According to the liquid crystal composition, a liquid crystal layer having little charge leakage can be achieved and a liquid crystal panel capable of ensuring both good display quality and low power consumption can be achieved.

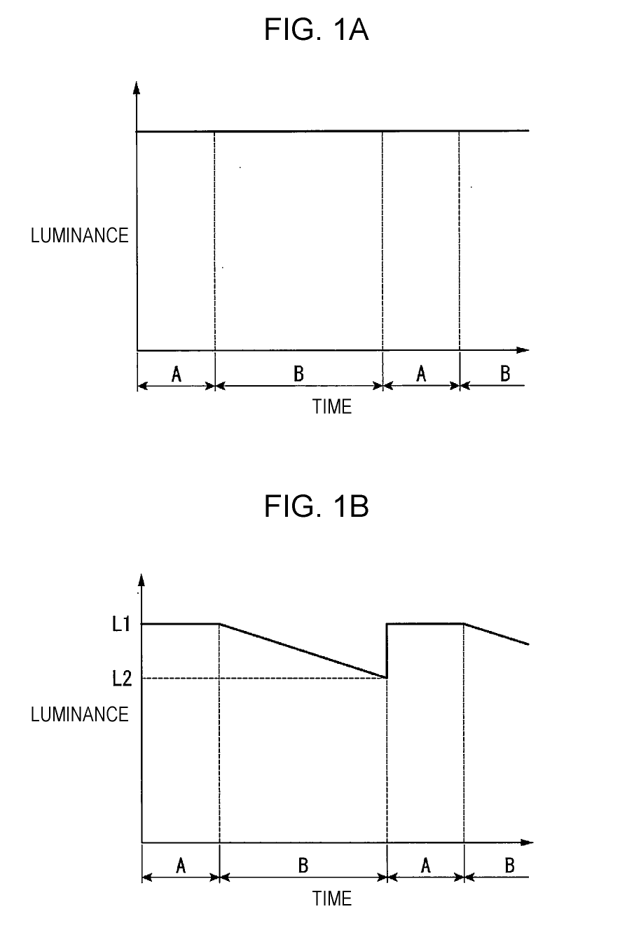

Problems with some aspects of the present invention and the fact that the problems can be solved by the liquid crystal composition are described below in detail. FIGS. 1A and 1B are illustrations showing the relationship between the operating time and luminance of a liquid crystal display.

For example, an active matrix addressing liquid crystal display in a normally black mode performs white display in such a manner that a potential difference is induced between a pair of electrodes included in a liquid crystal panel and is applied to a liquid crystal layer and also performs black display in such a manner that no potential difference is applied to the liquid crystal layer. In this case, the application of a potential difference to the liquid crystal layer during white display does not continue during white display. As shown in FIG. 1A, the following two states are alternately repeated: a state in which a potential difference is applied for a certain period (an operating period A) and a state in which no potential difference is applied for a certain period (an idling period B).

In the idling period B, the liquid crystal layer is oriented at the same potential difference as that in the operating period A as long as the potential difference induced between the pair of electrodes is maintained. Therefore, in the liquid crystal display, an image with the same luminance as that in the operating period A is displayed even in the idling period B, in which no potential difference is induced between the pair of electrodes (no potential difference is applied to the liquid crystal layer).

In the operating period A, electricity is consumed in inducing a potential difference between the pair of electrodes. In the idling period B, no electricity is consumed in inducing a potential difference between the pair of electrodes. Therefore, if an idling period B between a certain operating period A and the next operating period A can be extended with the length of each operating period A remaining constant, then an operating period A included in a unit time (for example, 1 second) is shortened and low power consumption can be achieved.

However, in a conventional active matrix addressing liquid crystal display, charge gradually leaks in a liquid crystal layer during an idling period B and therefore the potential difference between a pair of electrodes drops. Then, as shown in FIG. 1B, the luminance decreases from L1 to L2 depending on the change in potential difference between the pair of electrodes. Inducing a potential difference between the pair of electrodes in an operating period A after an idling period B increases the luminance from L2 to L1.

When the difference between Luminance L1 and Luminance L2 is a difference between degrees that can be recognized by an observer viewing a liquid crystal display, such a change in luminance (L1→L2→L1→ . . . ) is recognized as a flicker by the observer and has been a cause of poor image quality. Extending an idling period B for the purpose of reducing power consumption increases the difference between Luminance L1 and Luminance L2 and is likely to lead to a difficulty in displaying a good image. Therefore, the idling period B can only be extended to such a degree that no flicker is recognized in an image by the observer. This has hindered the reduction of power consumption.

The resistivity of a liquid crystal composition for use in a liquid crystal layer is usually very high, about 10¹³ Ωcm and therefore the leakage of charge is probably unlikely to occur. Nevertheless, in an actual liquid crystal display, charge leaks and the luminance varies in an idling period B. Therefore, in the actual liquid crystal display, it can be judged that a liquid crystal composition contained in a liquid crystal layer has reduced resistivity.

In this regard, the inventors have performed intensive investigations and have found that a liquid crystal composition used in a liquid crystal layer of a liquid crystal panel is contaminated from a component in contact with the liquid crystal layer during or after the preparation of the liquid crystal panel and therefore has reduced resistivity.

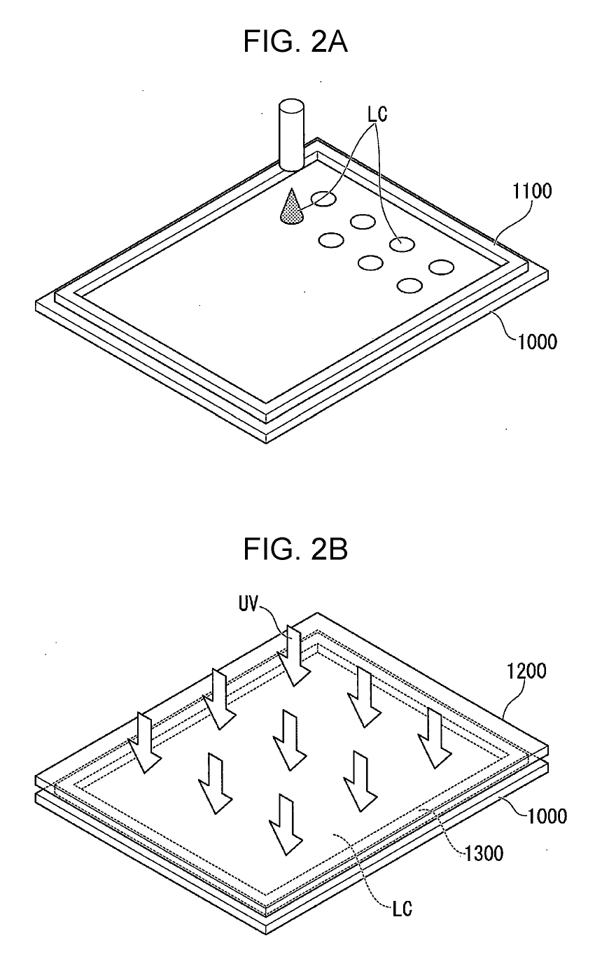

FIGS. 2A and 2B are illustrations showing typical steps of manufacturing a liquid crystal panel. FIGS. 2A and 2B show manufacturing steps of a process referred to as ODF (one-drop fill).

Upon manufacturing the liquid crystal panel, as shown in FIG. 2A, a sealing material 1100 is placed on a surface of a substrate 1000 in a frame pattern and a liquid crystal composition LC is dripped into an area surrounded by the sealing material 1100. The sealing material 1100 is formed from a photocurable resin composition.

Thereafter, as shown in FIG. 2B, a substrate 1200 is overlaid on the sealing material 1100, whereby the liquid crystal composition LC is spread in a space surrounded by the substrates 1000 and 1200 and the sealing material 1100. Furthermore, light (for example, an ultraviolet ray UV) with a wavelength for curing the sealing material 1100 is applied to the sealing material 1100, whereby a sealing section 1300 is formed and the liquid crystal composition LC is sealed.

The formation of the sealing material 1100 and the dripping of the liquid crystal composition LC are performed on the same substrate 1000 as shown in FIGS. 2A and 2B and are not limited to this. The formation of the sealing material 1100 and the dripping of the liquid crystal composition LC may be performed separately on the substrate 1000 and the substrate 1200, followed by overlaying the substrate 1000 and the substrate 1200 on each other. In the case of manufacturing the liquid crystal panel by this method, the uncured sealing material 1100 comes into direct contact with the liquid crystal composition LC.

The liquid crystal composition LC used may be one having negative dielectric anisotropy or one having positive dielectric anisotropy. The property of “having negative dielectric anisotropy” is referred to as a “negative type”. The property of “having positive dielectric anisotropy” is referred to as a “positive type”.

When the liquid crystal panel to be manufactured is of an FFS (fringe field switching) type or an IPS (in-plane switching) type, the liquid crystal composition LC used may be of a negative type and a positive type. In these types of liquid crystal panels, using a negative type of liquid crystal composition allows the transmittance of a liquid crystal layer to be high during white display and is preferable in order to achieve low power consumption (see, for example, SID 2015 Digest, p. 735)).

When the liquid crystal panel to be manufactured is of a VA (vertical-alignment) type, the liquid crystal composition LC used is generally of a negative type.

In descriptions below, a negative type of liquid crystal composition is shown.

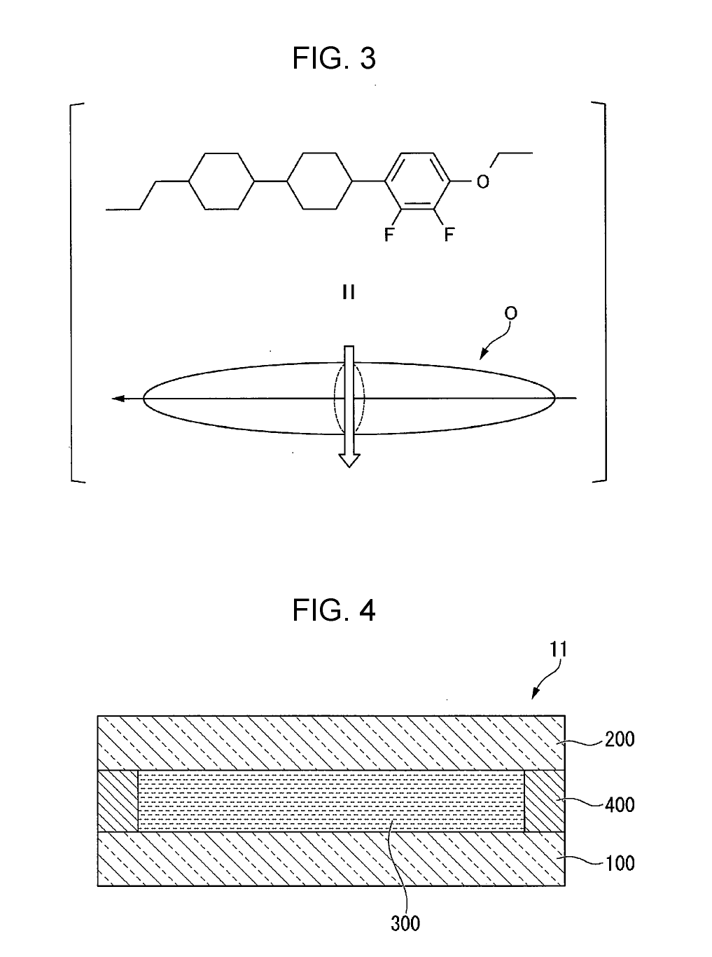

In order to readily modulate polarized light passing through the liquid crystal layer, the liquid crystal composition LC desirably has high dielectric anisotropy. FIG. 3 is an illustration showing an example of a liquid crystal molecule that is a major component of a conventional liquid crystal composition. Assuming a dielectric ellipsoid O, the liquid crystal molecule shown in FIG. 3 is a negative-type liquid crystal molecule which “has negative dielectric anisotropy” and which has a large dielectric constant in a minor axis direction because of fluorine atoms bonded to an aromatic ring. In this figure, a direction in which the dielectric constant is large is indicated by an open arrow. In descriptions below, the negative-type liquid crystal molecule is referred to as a “negative agent” in some cases.

A negative agent contains a polar group for the purpose of emphasizing the anisotropy of the dielectric constant of the liquid crystal molecule in some cases. In the liquid crystal molecule, which is a negative agent, shown in FIG. 3, for example, an alkoxy group is bonded to an aromatic ring for the purpose of emphasizing the dielectric anisotropy.

The liquid crystal composition LC is required to have liquid crystallinity at room temperature and a viscosity sufficient to quickly vary the alignment depending on the applied potential. Therefore, the liquid crystal composition LC contains a liquid crystal molecule, such as a liquid crystal molecule unsubstituted with fluorine or a liquid crystal molecule containing a small number of fluoro groups, having a dielectric anisotropy with an absolute value (|Δε|) less than that of a negative-type liquid crystal molecule used in addition to a negative agent in some cases. Such a liquid crystal molecule having a small negative dielectric anisotropy is referred to as a “neutral agent” in some cases.

That is, the liquid crystal composition LC, which is of a usual negative type, is generally a mixture of a negative agent and a neutral agent mixed at a predetermined ratio. Therefore, for example, a liquid crystal composition containing a large amount of the liquid crystal molecule shown in FIG. 3 as a negative agent is expected to have polarity by the action of a polar group contained in the negative agent.

On the other hand, a main component making up the sealing material is a compound containing a functional group, such as an epoxy group or a (meth)acrylate group, having high polarity. An additive typified by a photopolymerization initiator is often one which contains a functional group, such as a carbonyl group, having high polarity and which is highly polar.

When the sealing material is in contact with a liquid crystal composition containing a large amount of the liquid crystal molecule shown in FIG. 3, a polar component (a compound having polarity) or low-molecular weight component (low-molecular weight compound) in the sealing material is likely to dissolve in the liquid crystal composition. In the manufacturing steps shown in FIGS. 2A and 2B, the liquid crystal composition is in contact with the uncured sealing material. Therefore, the low-molecular weight component, which is contained in the uncured sealing material, dissolves in the liquid crystal composition. As a result, the resistivity of the liquid crystal composition decreases.

In addition, an alignment film is cited as a component in contact with the liquid crystal composition. In the case where the alignment film is formed from polyimide, byproducts such as amines and acid anhydrides may possibly be formed when polyamic acid is imidized by heating. When the alignment film is a degradable photoalignment film, maleimide is formed as a byproduct as a result of a photolytic reaction. These byproducts contain a functional group, such as an amino group or a carbonyl group, having high polarity and have high polarity. Therefore, when the liquid crystal composition is in contact with the alignment film, the byproducts contained in the alignment film dissolve in the liquid crystal composition, whereby the resistivity of the liquid crystal composition may possibly be reduced.

The inventors have focused on the above-mentioned respect and have considered that a problem can be solved in such a manner that a liquid crystal composition in which a polar compound or a low-molecular weight compound is unlikely to dissolve is obtained. The inventors have performed intensive investigations and, as a result, have completed some aspects of the present invention.

In the first liquid crystal molecules, which are represented by Formula (A), R¹ and R⁵ bonded to both ends are the linear alkyl groups containing 1 to 8 carbon atoms. Such a compound contains a smaller number of polar groups as compared to such a compound as exemplified in FIG. 3. In the liquid crystal composition, which contains 17 mol % or more of the first liquid crystal molecules with respect to the whole liquid crystal molecules, polar compounds and low-molecular weight compounds are unlikely to dissolve.

On the other hand, the first liquid crystal molecules have a small dipole moment as the first liquid crystal molecules contain no substituent (alkoxy group) emphasizing the dielectric anisotropy. Therefore, in the liquid crystal composition according to this embodiment, necessary dielectric anisotropy can be exhibited by appropriately controlling the mixing ratio of the negative agent and the neutral agent.

The liquid crystal composition according to this embodiment preferably contains 50 mol % or more of the first liquid crystal molecules with respect to the whole liquid crystal molecules.

The liquid crystal composition according to this embodiment preferably contain less than 50 mol % of second liquid crystal molecules containing an alkoxy group in the molecules with respect to the whole liquid crystal molecules. The term “second liquid crystal molecule containing an alkoxy group in the molecule” refers to, for example, a compound which has a molecular structure similar to that of the first liquid crystal molecules represented by Formula (A) like the compound shown in FIG. 3 and in which R¹ and R⁵, bonded to both ends, in Formula (A) are alkoxy groups unlike the first liquid crystal molecules. The alkoxy groups are, for example, linear alkoxy groups containing 1 to 8 carbon atoms.

Furthermore, the liquid crystal composition according to this embodiment is likely to transform into a nematic phase suitable for liquid crystal layers for liquid crystal panels instead of a smectic phase which is a layered structure and therefore preferably has a configuration below.

The liquid crystal composition according to this embodiment preferably contains the first liquid crystal molecules and third liquid crystal molecules, represented by Formula (A), different from the first liquid crystal molecules.

In this case, the total number of R² groups and R⁴ groups in each first liquid crystal molecule is preferably equal to the total number of R² groups and R⁴ groups in each third liquid crystal molecule. When the first liquid crystal molecule contains four six-membered rings including an R² group, an R³ group, and an R⁴ group, the third liquid crystal molecule preferably contains four six-membered rings including an R² group, an R³ group, and an R⁴ group.

Such a configuration is preferable because the compatibility between the first liquid crystal molecule and the third liquid crystal molecule is good.

Furthermore, in this case, the difference between the sum of the number of carbon atoms in an R¹ group and the number of carbon atoms in an R⁵ group in the first liquid crystal molecule and the sum of the number of carbon atoms in an R¹ group and the number of carbon atoms in an R⁵ group in the third liquid crystal molecule is preferably 1. When the R¹ group and R⁵ group in the first liquid crystal molecule are both, for example, propyl groups, the sum of the number of carbon atoms in the R¹ group and the number of carbon atoms in the R⁵ group is 6. In this case, the sum of the number of carbon atoms in the R¹ group and the number of carbon atoms in the R⁵ group in the third liquid crystal molecule is preferably 5 to 7. In such a combination, the R⁵ group is an ethyl group or a butyl group when the R¹ group is, for example, a propyl group.

In a liquid crystal composition having such a configuration, even if molecules attempt to align in layers, a layered structure is unlikely to be formed as a whole because the lengths of alkyl groups are slightly different and therefore a surface of a layer is disordered. Therefore, a nematic phase suitable for liquid crystal layers for liquid crystal panels is likely to be formed instead of a smectic phase which is a layered structure.

Furthermore, in the liquid crystal composition according to this embodiment, it is preferable that the number of R² groups in the first liquid crystal molecule is equal to the number of R² groups in the third liquid crystal molecule and the number of R⁴ groups in the first liquid crystal molecule is equal to the number of R⁴ groups in the third liquid crystal molecule.

The difference between the sum of the number of carbon atoms in the R¹ group and the number of carbon atoms in the R⁵ group in the first liquid crystal molecule and the sum of the number of carbon atoms in the R¹ group and the number of carbon atoms in the R⁵ group in the third liquid crystal molecule is preferably 1.

Furthermore, it is preferable that the R² groups in the first liquid crystal molecule are the same as the R² groups in the third liquid crystal molecule, the R: group in the first liquid crystal molecule is the same as the R³ group in the third liquid crystal molecule, and the R⁴ groups in the first liquid crystal molecule are the same as the R⁴ groups in the third liquid crystal molecule.

In the liquid crystal composition, it is preferable that the total number of the R², R³, and R⁴ groups in the first liquid crystal molecule and the total number of the R², R³, and R⁴ groups in the third liquid crystal molecule are both 3 and one of the R¹ and R⁵ groups in the first liquid crystal molecule and the R¹ and R⁵ groups in the third liquid crystal molecule is an n-propyl group.

When the liquid crystal composition contains liquid crystal molecules having such a configuration, a nematic phase is likely to be obtained at about room temperature.

In particular, compounds represented by Formulas (1) to (12) below can be cited as the above-mentioned first and third liquid crystal molecules. Elements making up the first and third liquid crystal molecules may include an isotope of carbon, hydrogen, fluorine, or the like.

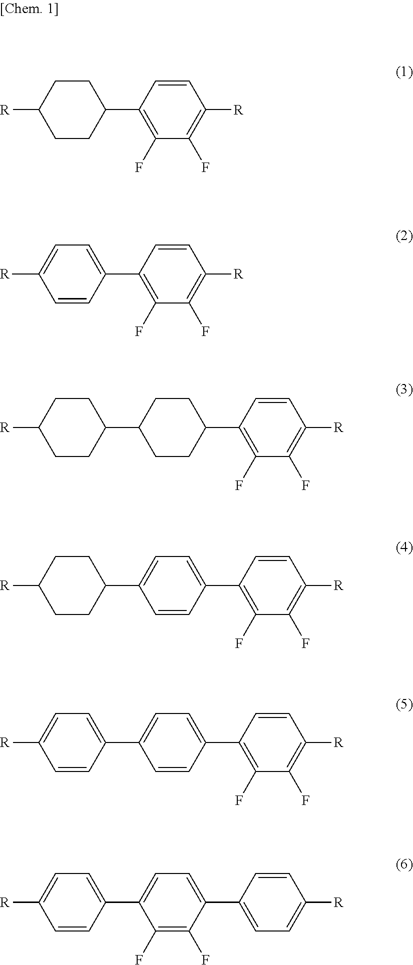

(where R represents a linear alkyl group containing 1 to 8 carbon atoms).

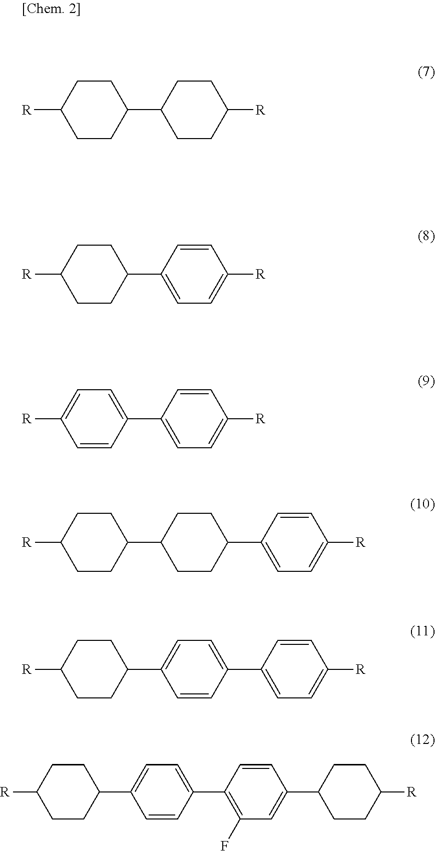

(where R represents a linear alkyl group containing 1 to 8 carbon atoms).

In the liquid crystal composition, the above-mentioned liquid crystal molecules are preferably blended in combination. As the number of types of the liquid crystal molecules contained in the liquid crystal composition is larger, the nematic phase temperature range can be more increased.

In a liquid crystal panel containing the liquid crystal composition having the above configuration, the resistivity of the liquid crystal composition, which is used in a liquid crystal layer, is unlikely to decrease. Therefore, the operating state of a liquid crystal panel including a liquid crystal layer containing the liquid crystal composition according to this embodiment is close to FIG. 1A. Thus, in the liquid crystal panel containing the liquid crystal composition according to this embodiment, good display quality with reduced flicker can be achieved.

In the liquid crystal panel containing the liquid crystal composition according to this embodiment, charge is unlikely to leak and the potential difference between a pair of electrodes is unlikely to decrease. Therefore, an idling period B can be extended and an operating period A included in a unit time (for example, 1 second) can be shortened during the operation of the liquid crystal panel as shown in FIGS. 1A and 1B. As a result, in the liquid crystal panel containing the liquid crystal composition according to this embodiment, low power consumption can be achieved.

Accordingly, in accordance with the liquid crystal composition having the above configuration, a liquid crystal panel ensuring both good display quality and low power consumption can be achieved.

### Second Embodiment

### (Liquid Crystal Panel, Liquid Crystal Display)

FIG. 4 is a schematic sectional view of a liquid crystal panel 11 according to this embodiment. As shown in FIG. 4, the liquid crystal panel 11 according to this second embodiment includes a device substrate (a pair of substrates) 100, a counter substrate (a pair of substrates) 200, a liquid crystal layer 300, and a sealing section 400. The above-mentioned liquid crystal composition according to this embodiment is used in the liquid crystal layer 300.

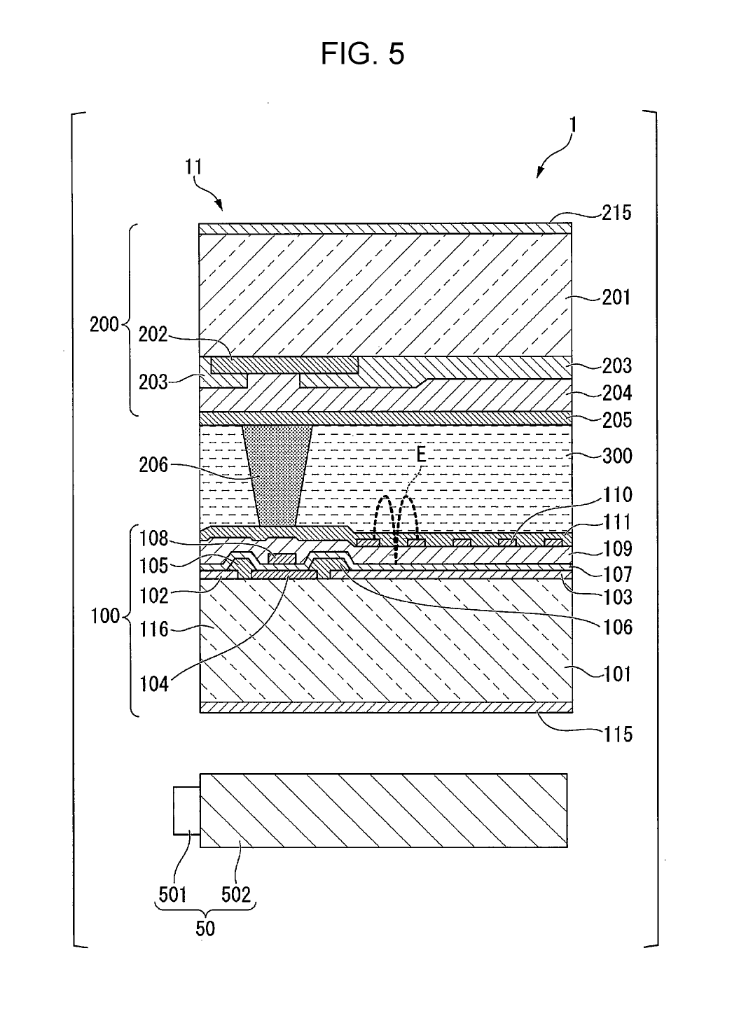

FIG. 5 is a schematic sectional view of the liquid crystal panel 11 and a liquid crystal display 1 according to this embodiment. FIG. 5 is a sectional view of a single pixel of the liquid crystal panel 11.

The liquid crystal display 1 according to this embodiment includes the liquid crystal panel 11 and a backlight 50.

The backlight 50 includes a light source 501 and a light guide 502. The light source 501 is placed on an end surface of the light guide 502. The light source 501 used is, for example, a light-emitting diode, a cold-cathode tube, or the like. The backlight 50 is an edge light type of backlight.

In the liquid crystal display 1 according to this embodiment, light emitted from the backlight 50 is varied in transmittance with the liquid crystal panel 11 and a predetermined image, character, or the like is displayed using passing light.

### (Liquid Crystal Panel)

The device substrate 100 includes a transparent base plate 101, signal electrodes 102, pixel electrodes 103, semiconductor layers 104, source electrodes 105, drain electrodes 106, a gate insulating film 107, gate electrodes 108, an interlayer insulating film 109, a common electrode 110, an alignment film 111, and a polarizer 115.

The signal electrodes 102, the pixel electrodes 103, and the semiconductor layers 104 are arranged on a surface of the transparent base plate 101 that is located on the liquid crystal layer 300 side. The signal electrodes 102 are electrically connected to the semiconductor layers 104 through the source electrodes 105. The pixel electrodes 103 are electrically connected to the semiconductor layers 104 through the drain electrodes 106.

IGZO (a quaternary alloy semiconductor material containing indium (In), gallium (Ga), zinc (Zn), and oxygen (O)) is preferably used as a material for the semiconductor layers 104. In the case of using IGZO to form the semiconductor layers 104, the off-state leakage currents in the obtained semiconductor layers 104 are small and therefore the leakage of charge from driving TFTs is suppressed. This enables an idling period after the application of a voltage to the liquid crystal layer 300 to be extended. As a result, the number of times that a voltage is applied during a period in which an image is displayed can be reduced, thereby reducing the power consumption of the liquid crystal panel 11.

Components such as the signal electrodes 102, the pixel electrodes 103, the semiconductor layers 104, the source electrodes 105, and the drain electrodes 106 are covered by the gate insulating film 107. The gate insulating film 107 is formed from, for example, a light-transmissive insulating inorganic material such as silicon dioxide or silicon nitride or a light-transmissive insulating resin material such as polyimide, polymethyl (meth)acrylate, or an epoxy resin.

Each of the gate electrodes 108 is placed at a position which is on a surface of the gate insulating film 107 and which overlaps a corresponding one of the semiconductor layers 104 in plan view. The gate electrodes 108 are connected to scanning electrodes, which is not shown. Each of the semiconductor layers 104, a corresponding one of the source electrodes 105, a corresponding one of the drain electrodes 106, and a corresponding one of the gate electrodes 108 form a driving TFT in the liquid crystal panel 11.

The interlayer insulating film 109 extends over the upper surface of the gate insulating film 107 so as to cover the gate electrode 108. The interlayer insulating film 109, as well as the gate insulating film 107, is formed from, for example, an inorganic material or a resin material.

The common electrode 110 is placed at a position which is on a surface of the interlayer insulating film 109 and which overlaps each pixel electrode 103 in plan view. The common electrode 110 has an interdigital shape formed by patterning. Applying a voltage between the common electrode 110 and the pixel electrode 103 allows an electric field represented by symbol E to be induced, thereby allowing liquid crystal molecules in the liquid crystal layer 300 to align along the electric field.

The alignment film 111 extends over the upper surface of the interlayer insulating film 109 so as to cover the common electrode 110. The alignment film 111 used may be a photoalignment film or a rubbing alignment film.

The photoalignment film is formed from a polymeric material containing a photofunctional group. The photofunctional group is one that absorbs light to isomerize to the cis- or trans-isomer (a photoisomerization type), one that absorbs light to dimerize (a photodimerization type), or one that absorbs light to decompose (a photodecomposition type). The photoalignment film is formed by applying polarized light to the polymeric material, which contains the photofunctional group. The photodecomposition type absorbs less visible light and has higher thermal stability as compared to the photoisomerization type and the photodimerization type. Therefore, the photodecomposition type is preferable because light from a backlight is absorbed, the resistivity of the alignment film is reduced by the generation of photocarriers, and the reliability of the alignment film is high. In the photodecomposition type, applying polarized light to the polymeric material, which contains the photofunctional group, allows the polymeric material to decompose in the same direction as a polarization direction and allows the polymeric material to remain in a direction perpendicular to the polarization direction. This differentiates the anchoring force of liquid crystal molecules between the polarization direction and the direction perpendicular to the polarization direction, thereby allowing the alignment film to be used.

Since the rubbing alignment film is concerned about contamination with rubbing cloth used during manufacture, the alignment film 111 is preferably the photoalignment film.

A polyimide with a main chain containing cyclobutane diimide represented by Formula (X) below is cited as a material for forming the photoalignment film.

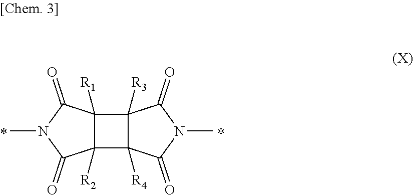

The polyimide, which has a structure represented by Formula (X), forms maleimide when a cyclobutane ring is opened by photoirradiation. Since maleimide has a small molecular weight, maleimide dissolves in the liquid crystal layer 300 and may possibly cause the leakage of charge. Therefore, in the case of using the polyimide, which has the structure represented by Formula (X), to form the photoalignment film, low-molecular weight components formed after photoirradiation are removed by repolymerization, sublimation, or washing. However, it is difficult to completely remove the low-molecular weight components.

In the liquid crystal panel 11 according to this embodiment, even if the low-molecular weight components, such as maleimide, remain, the dissolution of the low-molecular weight components in the liquid crystal layer 300 is suppressed because the liquid crystal composition according to an aspect of the present invention is used in the liquid crystal layer 300. Therefore, the leakage of charge in the liquid crystal layer 300 is suppressed and the liquid crystal panel 11 can hold an applied voltage well.

The polarizer 115 used may be one having a usually known configuration.

The counter substrate 200 includes a transparent base plate 201, a black matrix 202, a color filter layer 203, a planarization layer 204, an alignment film 205, spacers 206, and a polarizer 215.

The transparent base plate 201 used may be one having the same configuration as that of the transparent base plate 101.

The black matrix 202 is placed on a surface of the transparent base plate 201 that is located on the liquid crystal layer 300 side. The black matrix 202 is a light-shielding member formed in a grid pattern using a light-shielding material such as a metal material including chromium or a resin material colored black and has an opening for each pixel.

The color filter layer 203 is placed so as to overlap an opening section of the black matrix 202 in plan view. The color filter layer 203 includes, for example, a red color filter sublayer which absorbs a portion of light and which transmits red light, a green color filter sublayer which absorbs a portion of light and which transmits green light, and a blue color filter sublayer which absorbs a portion of light and which transmits blue light.

The planarization layer 204 extends over the color filter layer 203 and the black matrix 202. The planarization layer 204 is formed from a light-transmissive insulating material.

The alignment film 205 used may be one having a usually known configuration. The alignment film 205 may be, for example, one having the same configuration as that of the above alignment film ill.

The polarizer 215 is placed on a surface of the transparent base plate 201 that is opposite to the liquid crystal layer 300.

A polarizer 215 used may be one having a usually known configuration. The polarizer 215 and the polarizer 115 are arranged in, for example, a crossed Nicol state.

The spacers 206 are columnar structures used to regulate the thickness of the liquid crystal layer 300.

The device substrate 100 and the counter substrate 200 sandwich the liquid crystal layer 300 in such a state that the alignment films 111 and 105 are placed opposite to each other. The liquid crystal layer 300 contains the above-mentioned liquid crystal composition according to this embodiment. The liquid crystal composition in a voltage-free state is provided with orientation depending on the anchoring force of the alignment films 111 and 205.

As shown in FIG. 4, the sealing section 400 is interposed between the device substrate 100 and the counter substrate 200 and is placed around the liquid crystal layer 300.

A material for forming the sealing section 400 is preferably a photocurable resin composition or a thermosetting resin composition. In particular, a curable resin composition containing an epoxy resin represented by Formula (Y1) below or a (meth)acrylic resin represented by Formula (Y2) or (Y3) below as a base resin is preferable. Structures represented by Formulas (Y4) to (Y6) below can be exemplified as a structure represented by X in Formulas (Y1) to (Y3).

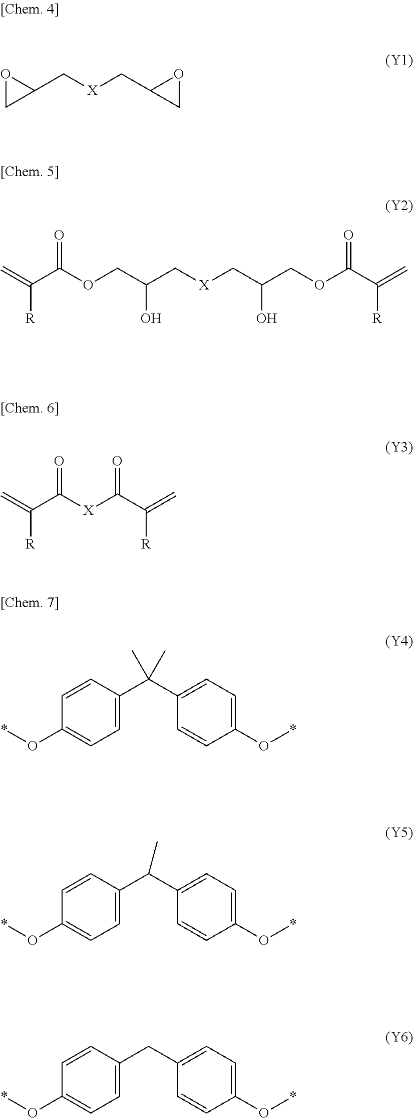

As a polymerization initiator used in the material for forming the sealing section 400, one containing a benzoyl group represented by Formula (Z) below is cited.

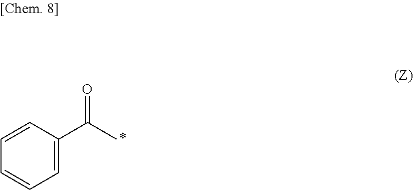

As a thermal curing agent used in the material for forming the sealing section 400, at least one of one containing primary to tertiary amines, hydrazides, and imidazoles is cited.

In addition, a curable resin composition used in the material for forming the sealing section 400 may contain filler and/or a silane coupling agent.

Compounds contained in the above-mentioned curable resin composition contain a polar group such as an epoxy group, a carbonyl group, an amino group, or a siloxane group. These compounds have a problem that a sealing material dissolves in a liquid crystal composition if the uncured sealing material comes into contact with the liquid crystal composition when the liquid crystal composition is sealed by an ODF process.

Slight amounts of unreacted components remain in a sealing section 400 obtained after the sealing material is cured. Therefore, there is a problem in that slight amounts of the unreacted components dissolve in the liquid crystal composition when the sealing section is in contact with the liquid crystal composition.

In the liquid crystal panel 11 according to this embodiment, even if the compounds containing the polar group or the unreacted components remain, the dissolution of the compounds containing the polar group or the unreacted components in the liquid crystal layer 300 can be suppressed because the liquid crystal composition according to an aspect of the present invention is used in the liquid crystal layer 300. Therefore, the leakage of charge in the liquid crystal layer 300 is suppressed and the liquid crystal panel 11 can hold an applied voltage well.

The liquid crystal panel 11 may further include an auxiliary capacitor connected in series to each pixel electrode 103 and the common electrode 110. The auxiliary capacitor holds the same potential as the potential applied between the pixel electrode 103 and the common electrode 110 to play a role in compensating for the leakage of charge in the liquid crystal layer 300 and the driving TFT.

In the liquid crystal panel 11 according to this embodiment, the liquid crystal layer 300 is preferably sealed by the ODF process during manufacture. In the liquid crystal panel 11 according to this embodiment, since the liquid crystal composition according to an aspect of the present invention is used in the liquid crystal layer 300, components of the uncured sealing material are unlikely to dissolve in the liquid crystal layer. Therefore, even though the ODF process is used during manufacture, a failure such as a reduction in image quality or an increase in power consumption is unlikely to occur and an increase in productivity due to the reduction in injection time of a liquid crystal can be achieved.

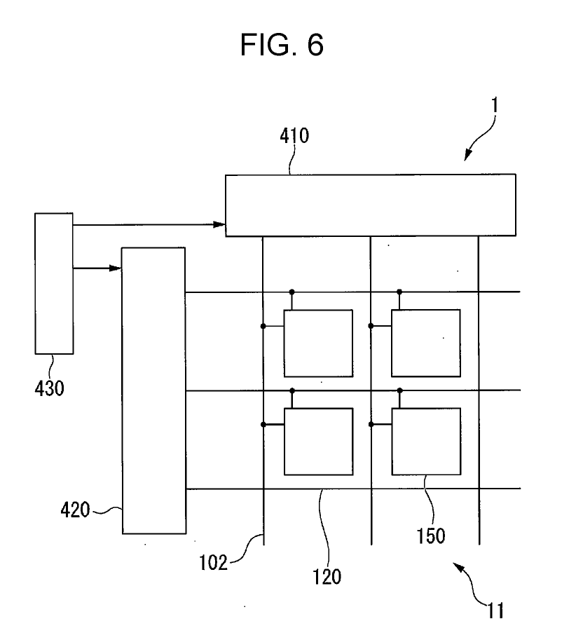

FIG. 6 is a circuit diagram of the liquid crystal display 1 according to this embodiment. As shown in FIG. 6, the liquid crystal display 1 includes the above-mentioned liquid crystal panel 11 and a controller 430 supplying a driving signal to the liquid crystal panel 11.

In the liquid crystal panel 11, a plurality of pixels 150 are arranged in a matrix pattern. The signal electrodes 102 are connected to a source driver group 410. Scanning electrodes 120 are connected to a gate driver group 420. Furthermore, the source driver group 410 and the gate driver group 420 are connected to the controller 430. The controller 430 has a role in controlling the timing of a driving signal to each of the source driver group 410 and the gate driver group 420.

In order to operate the liquid crystal panel 11 to display an image, rectangular voltage signals (driving signals) are applied to the gate electrodes of the driving TFTs through the scanning electrodes 120. This turns on the driving TFTs and currents flow through the pixel electrodes 103, whereby voltages are applied between the pixel electrodes 103 and the common electrode 110. A period in which the rectangular voltage signals are input to operate the liquid crystal panel 11 is an operating period A shown in FIGS. 1A and 1B.

On the other hand, during a period in which no rectangular voltage signals are applied to the gate electrodes of the driving TFTs, the alignment of liquid crystal is maintained by the voltage held in the liquid crystal layer 300. This allows the liquid crystal panel 11 to maintain the same luminance as that during the input of voltage signals. A period in which no voltage signals are input is an idling period B shown in FIGS. 1A and 1B. The duration of a series of the operating period A and the idling period B is referred to as a frame. Repeating the frame allows an image with constant luminance to be displayed.

In the liquid crystal panel 11, extending the idling period B per unit time enables the reduction of power consumption. However, extending the idling period B increases the influence of the leakage of charge in the liquid crystal layer 300 and the driving TFTs, thereby causing poor image quality such as a reduction in luminance or a flicker.

In the liquid crystal panel 11 according to this embodiment, even if the frame frequency is reduced from 60 Hz, which is common to conventional liquid crystal panels, poor image quality is not caused because the liquid crystal composition according to an aspect of the present invention is used in the liquid crystal layer 300. Even if, for example, the controller 430 supplies a driving signal of less than 60 Hz or a driving signal of less than 30 Hz to the liquid crystal panel 11, poor image quality is unlikely to be caused.

According to the liquid crystal panel 11, which has the above configuration, good display quality and low power consumption can be both achieved.

According to the liquid crystal display 1, which has the above configuration, good display quality and low power consumption can be both achieved.

### Third Embodiment

### (Electronic Device)

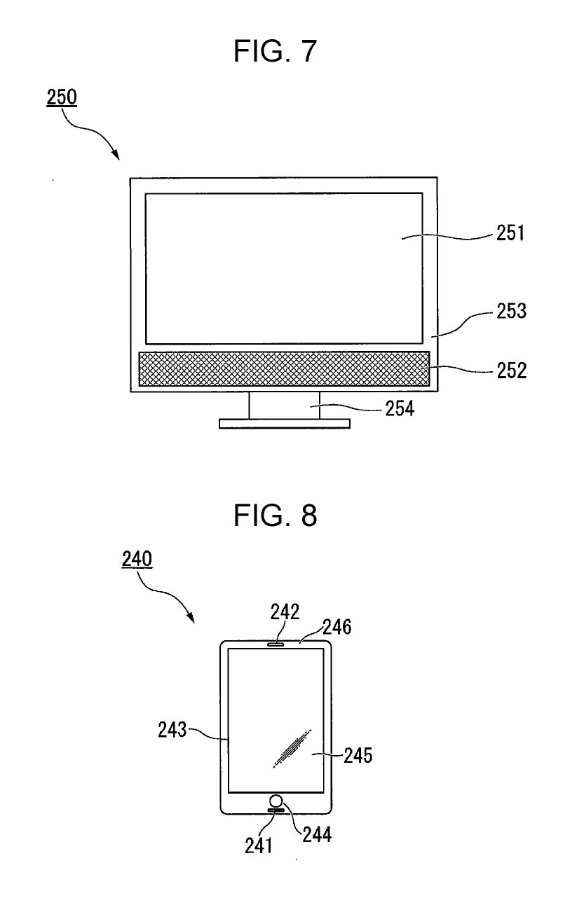

FIGS. 7 to 10 are schematic views of an electronic device according to this embodiment. The electronic device according to this embodiment includes the above-mentioned liquid crystal panel and a controller supplying a driving signal to the liquid crystal panel.

FIG. 7 shows a flat-panel television 250 including a display section 251, a speaker 252, a cabinet 253, a stand 254, and the like. The display section 251 may be the above-mentioned liquid crystal panel, which is preferably used. This enables good display quality and low power consumption to be both achieved.

FIG. 8 shows a smartphone 240 including a voice input section 241, a voice output section 242, an operating switch 244, a display section 245, a touch panel 243, a housing 246, and the like. The display section 245 may be the above-mentioned liquid crystal panel, which is preferably used. This enables good display quality and low power consumption to be both achieved.

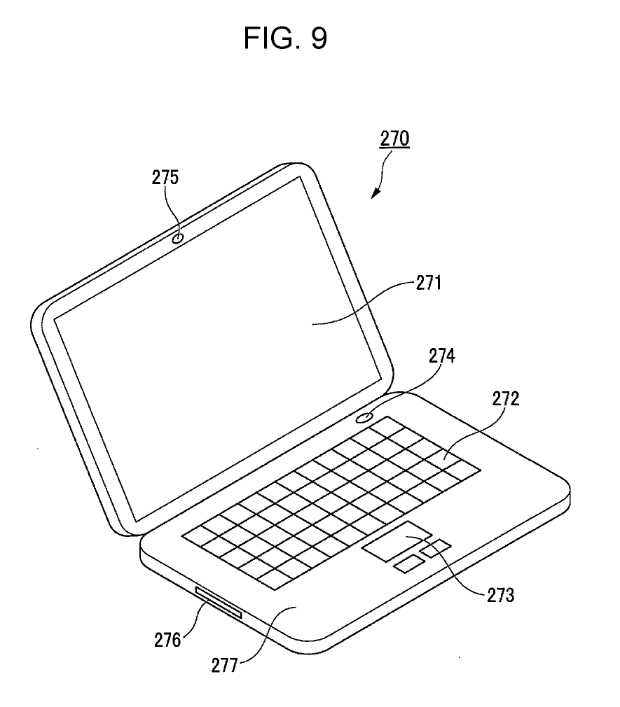

FIG. 9 shows a notebook personal computer 270 including a display section 271, a keyboard 272, a touch pad 273, a main switch 274, a camera 275, a recording media slot 276, a housing 277, and the like.

The display section 271 may be the above-mentioned liquid crystal panel, which is preferably used. This enables good display quality and low power consumption to be both achieved.

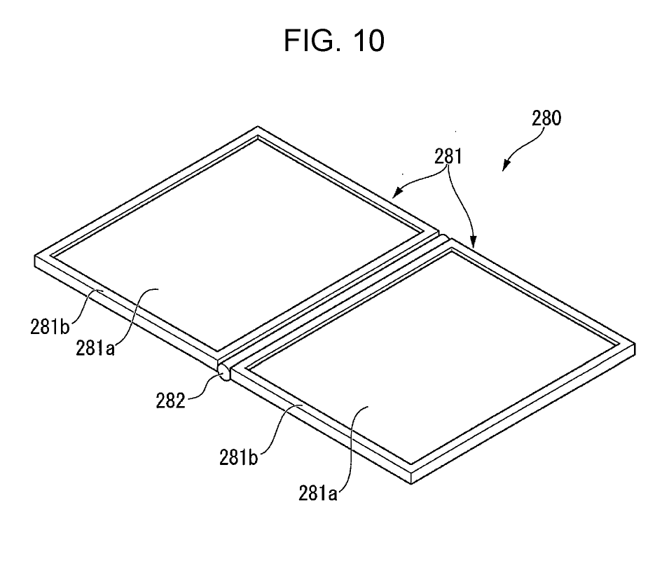

FIG. 10 shows a mobile electronic device 280 including two display sections 281 and a hinge mechanism 282 connecting the two display sections 281. Using the hinge mechanism 282 enables the display sections 281 to be folded. The display sections 281 each include a display panel 281a and a housing 281b. The display panel 281a may be the above-mentioned liquid crystal panel, which is preferably used. This enables good display quality and low power consumption to be both achieved. Low power consumption allows the battery capacity to be less than that of conventional mobile electronic devices, thereby enabling weight reduction.

The display sections 281 may be overlaid with a free-form-surface lens. Using such a lens enables images on the two display sections 281 to be seamlessly displayed.

The electronic device according to this embodiment includes the controller, which supplies a driving signal to the liquid crystal panel. In the electronic device according to this embodiment, the above-mentioned liquid crystal panel is used. Therefore, even if the controller supplies a driving signal of less than 60 Hz or a driving signal of less than 30 Hz to the liquid crystal panel, poor image quality is unlikely to be caused.

While preferred embodiments of the present invention have been described with reference to the attached drawings, it is obvious that the present invention is not limited to the embodiments. The shapes, combinations, and the like of components described in the embodiments are illustrative only and may be variously modified on the basis of design requirements or the like without departing from the spirit of the invention.

### EXAMPLES

The present invention is described below with reference to examples. The present invention is not limited to the examples.

### Examples 1 and 2

Liquid crystal compositions with a composition ratio shown in Table 1 below were prepared.

TABLE 1

| | Example 1 | Example 2 |
|---|---|---|
| 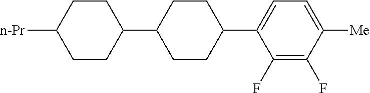 | 8.5 | 51.8 |
| 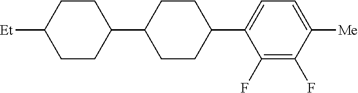 [SMILES: CCC1CCC(C2CCC(c3ccc(C)c(F)c3F)CC2)CC1] | 8.5 | 4.5 |
| 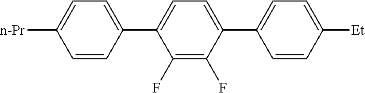 | 8.2 | 4.3 |
| 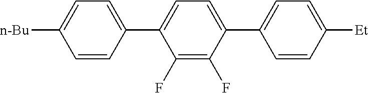 | 2.6 | 1.4 |
| 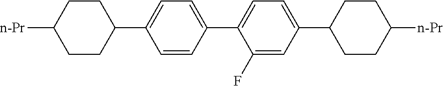 | 1.3 | 0.7 |
| 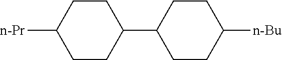 | 26.1 | 13.7 |
| Subtotal | 55.2 | 76.4 |
| 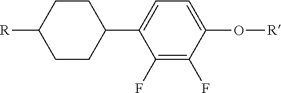 | 44.8 | 23.6 |
| 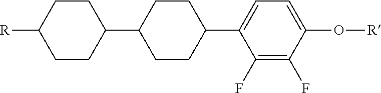 | | |
| 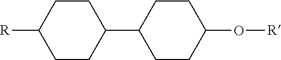 | | |
| 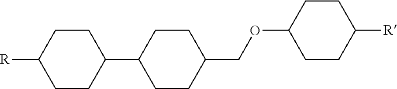 | | |
| Total | 100 | 100 |

### Example 3

A liquid crystal composition with a composition ratio shown in Table 2 below was prepared.

TABLE 2

| | Example 3 |
|---|---|
| 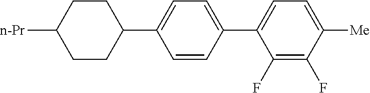 | 18.4 |
| 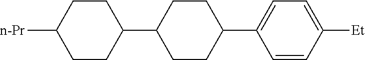 | 81.6 |
| Total | 100 |

### Comparative Example 1

A liquid crystal composition with a composition ratio shown in Table 3 below was prepared.

TABLE 3

| | Comparative Example 1 |
|---|---|
| 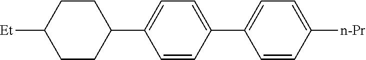 | 16.7 |
| 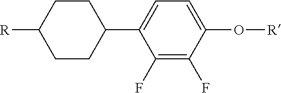 | 58.3 |
| 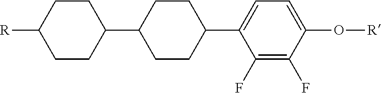 | |
| 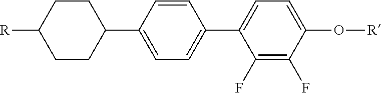 | 25.0 |
| 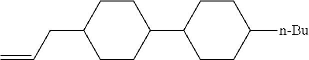 | |
| 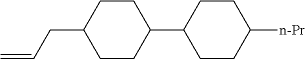 | |
| Total | 100 |

### (Evaluation 1)

The liquid crystal compositions described in above Examples 1 to 3 and Comparative Example 1 were measured for nematic phase-liquid phase transition temperature (Tni) and nematic phase temperature range. The results are shown in Table 4. Incidentally, the phase transition temperature was measured by differential scanning calorimetry (DSC). The nematic phase temperature range was measured in such a manner that each liquid crystal composition was heated using a polarizing microscope equipped with a heating state and was observed for liquid phase with the polarizing microscope.

TABLE 4

| | Example | Example | Example | Comparative |
|---|---|---|---|---|
| | 1 | 2 | 3 | Example 1 |
| Phase transition | 76.1 | 109.5 | 130.2 | 80.5 |
| temperature (Tni) | | | | |
| [° C.] | | | | |
| Temperature range | 125.2 | 113.1 | 105.9 | 120.1 |
| of nematic phase | | | | |
| [° C.] | | | | |

As a result of evaluation, it could be confirmed that, among the liquid crystal compositions, the liquid crystal compositions described in the above Examples 1 and 2 that contained many types (six types) of compounds represented by Formula (1) had a wider nematic phase temperature range as compared to the liquid crystal composition of Example 3 that was composed of two types of compounds represented by Formula (1).

### (Evaluation 2)

The solubility of a sealing material in each of the liquid crystal compositions described in the above Examples 1 to 3 and Comparative Example 1 was evaluated by a method below.

First, 10% by mass of a sealing material (Photolec S, produced by Sekisui Chemical Co., Ltd.) for an ODF process was added to each liquid crystal composition and the liquid crystal composition and the sealing material were contacted with each other for 1 hour at room temperature, followed by sampling the liquid crystal composition in which the sealing material was dissolved up to the saturation concentration thereof.

Next, the liquid crystal composition in which the sealing material was dissolved was measured by gas chromatography and the leaching concentration of the sealing material in the liquid crystal composition was determined from comparisons between the peak area of an internal standard, the sum of the peak areas of components of the sealing material, and the sum of the peak areas of the liquid crystal composition.

Incidentally, for gas chromatography, a nonpolar column was used for separation and a detector used was a flame ionization detector (FID). The internal standard used was acetone.

As a result of evaluation, it was clarified that the amount of the dissolved sealing material components was low in order of Example 3, Example 2, Example 1, and Comparative Example 1.

### (Evaluation 3)

The solubility of 1,4-phenylenediamine maleimide in each of the liquid crystal compositions described in the above Examples 1 to 3 and Comparative Example 1 was evaluated in substantially the same manner as that used in above (Evaluation 2) except that 1,4-phenylenediamine maleimide was used instead of the sealing material. As an example of a decomposition product of a photodecomposition-type alignment film, 1,4-phenylenediamine maleimide was used.

As a result of evaluation, it was clarified that the amount of dissolved 1,4-phenylenediamine maleimide was low in order of Example 3, Example 2, Example 1, and Comparative Example 1.

### (Evaluation 4)

Liquid crystal panels including a liquid crystal layer containing each of the liquid crystal compositions of Examples 1 to 3 and Comparative Example 1 were prepared using test cells having an FFS electrode structure. Incidentally, an ODF process was used to inject each liquid crystal composition and to bond the cells. Each liquid crystal panel was prepared through a step of allowing an uncured sealing material and the liquid crystal composition to be in contact with each other.

The prepared liquid crystal panels were evaluated for voltage holding ratio (VHR). The VHR was measured at an operating frequency of 1 Hz, which was dramatically lower than 60 Hz, which is the operating frequency of currently dominant liquid crystal display elements. The measurement temperature was 50° C., at which each liquid crystal composition exhibited a nematic phase.

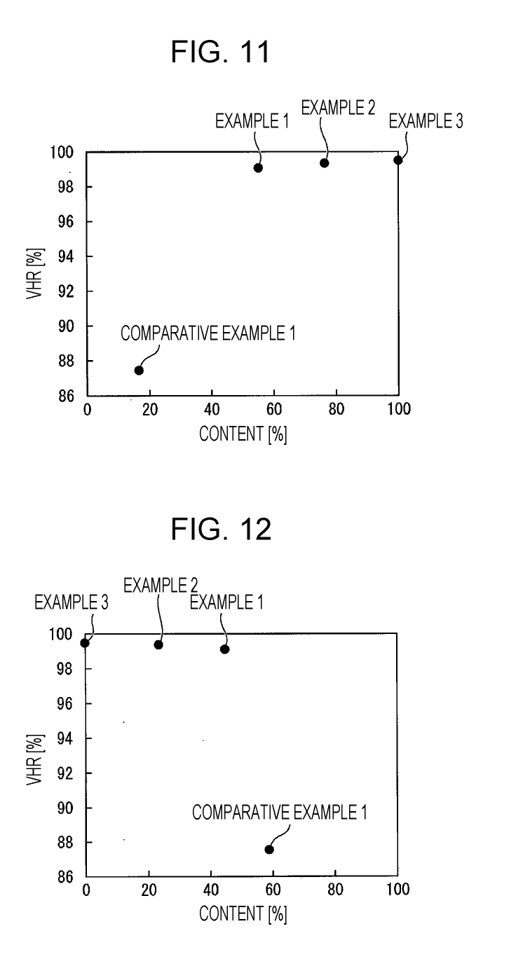

FIG. 11 is a graph showing the relationship between the content a compound represented by Formula (1) in each liquid crystal composition and the VHR.

FIG. 12 is a graph showing the relationship between the content a compound containing an alkoxy group in each liquid crystal composition and the VHR.

As shown in FIGS. 11 and 12, the liquid crystal panels containing the liquid crystal compositions of Examples 1 to 3 exhibited high VHR. However, the liquid crystal panel containing the liquid crystal composition of Comparative Example 1 exhibited reduced VHR as compared to the liquid crystal panels containing the liquid crystal compositions described in the above Examples 1 to 3.

From the above results, it was clear that some aspects of the present invention were useful.

### INDUSTRIAL APPLICABILITY

An aspect of the present invention is applicable to a liquid crystal composition necessary to achieve a liquid crystal panel ensuring both good display quality and low power consumption.

### REFERENCE SIGNS LIST

1 Liquid crystal display
11 Liquid crystal panel
100 Device substrate (a pair of substrates)
200 Counter substrate (a pair of substrates)
104 Semiconductor layers
111, 216 Alignment film
300 Liquid crystal layer
400 Sealing section
430 Controller
1000, 1200 Substrate
LC Liquid crystal composition

1. A liquid crystal composition containing liquid crystal molecules,
wherein the liquid crystal molecules include 17 mol % or more of first liquid crystal molecules represented by the following formula with respect to the whole liquid crystal molecules:
R¹—R²ₓ—R³—R⁴_{y}—R⁵ (A)
(where R¹ and R⁵ are linear alkyl groups containing 1 to 8 carbon atoms;
R² and R⁴ are trans-1,4-cyclohexylene groups or 1,4-phenylene groups; multiple R² and R⁴ may be the same as or different from each other;
R³ is a trans-1,4-cyclohexylene group, a 1,4-phenylene group, a 2,3-difluoro-trans-1,4-cyclohexylene group, a 2,3-difluoro-1,4-phenylene group, a 2,3-dichloro-trans-1,4-cyclohexylene group, or a 2,3-dichloro-1,4-phenylene group;
x is an integer of 0 to 3; and y is an integer of 0 to 3).

2. The liquid crystal composition according to claim 1, containing 50 mol % or more of the first liquid crystal molecules with respect to the whole liquid crystal molecules.

3. The liquid crystal composition according to claim 1, containing less than 50 mol % of second liquid crystal molecules containing an alkoxy group in the molecules with respect to the whole liquid crystal molecules.

4. The liquid crystal composition according to claim 1, containing the first liquid crystal molecules and third liquid crystal molecules, represented by Formula (A), different from the first liquid crystal molecules,
wherein the total number of R² groups and R⁴ groups in each first liquid crystal molecule is equal to the total number of R² groups and R⁴ groups in each third liquid crystal molecule and
the difference between the sum of the number of carbon atoms in an R¹ group and the number of carbon atoms in an R⁵ group in the first liquid crystal molecule and the sum of the number of carbon atoms in an R¹ group and the number of carbon atoms in an R⁵ group in the third liquid crystal molecule is 1.

5. The liquid crystal composition according to claim 4, wherein the number of the R² groups in the first liquid crystal molecule is equal to the number of the R² groups in the third liquid crystal molecule,
the number of R⁴ groups in the first liquid crystal molecule is equal to the number of the R⁴ groups in the third liquid crystal molecule,
the difference between the sum of the number of carbon atoms in the R¹ group and the number of carbon atoms in the R⁵ group in the first liquid crystal molecule and the sum of the number of carbon atoms in the R¹ group and the number of carbon atoms in the R⁵ group in the third liquid crystal molecule is 1,
the R² groups in the first liquid crystal molecule are the same as the R² groups in the third liquid crystal molecule, an R³ group in the first liquid crystal molecule is the same as an R³ group in the third liquid crystal molecule, and the R⁴ groups in the first liquid crystal molecule are the same as the R⁴ groups in the third liquid crystal molecule.

6. The liquid crystal composition according to claim 5,
wherein the total number of the R², R³, and R⁴ groups in the first liquid crystal molecule and the total number of the R², R³, and R⁴ groups in the third liquid crystal molecule are both 3 and
one of the R¹ and R⁵ groups in the first liquid crystal molecule and the R¹ and R⁵ groups in the third liquid crystal molecule is an n-propyl group.

7. A liquid crystal panel comprising:
a pair of substrates;
a liquid crystal layer interposed between the pair of substrates; and
a sealing section placed around the liquid crystal layer interposed between the pair of substrates,
wherein the pair of substrates each have a surface which is located on the liquid crystal layer side and which is provided with an alignment film and the liquid crystal layer is formed from the liquid crystal composition according to claim 1.

8. The liquid crystal panel according to claim 7, wherein the sealing section is formed from a curable resin.

9. The liquid crystal panel according to claim 7, wherein the alignment film is formed from a polymeric material containing a photofunctional group and the photofunctional group absorbs light to decompose.

10. The liquid crystal panel according to claim 7, wherein one of the pair of substrates includes an electrode and a driving TFT controlling the voltage applied to the electrode and
the driving TFT includes a semiconductor layer formed from an oxide semiconductor.

11. A liquid crystal display comprising:
the liquid crystal panel according to claim 7; and
a controller supplying a driving signal to the liquid crystal panel.

12. The liquid crystal display according to claim 11, wherein the controller supplies the driving signal of less than 60 Hz to the liquid crystal panel.

13. The liquid crystal display according to claim 11, wherein the controller supplies the driving signal of less than 30 Hz to the liquid crystal panel.

14. An electronic device comprising:
the liquid crystal panel according to claim 7; and
a controller supplying a driving signal to the liquid crystal panel.

15. The electronic device according to claim 14, wherein the controller supplies the driving signal of less than 60 Hz to the liquid crystal panel.

16. The electronic device according to claim 14, wherein the controller supplies the driving signal of less than 30 Hz to the liquid crystal panel.
